(19) United States
(12) Patent Application Publication
(10) Pub. No.: US 2014/0366515 A1
(43) Pub. Date: Dec. 18, 2014

(54) ENHANCED DIAGNOSTIC SIGNAL TO DETECT PRESSURE CONDITION OF A PARTICULATE FILTER

(71) Applicant: GM Global Technology Operations LLC, Detroit, MI (US)

(72) Inventors: Janean E. Kowalkowski, Northville, MI (US); Vincent J. Tylutki, Livonia, MI (US); Benjamin Radke, Waterford, MI (US); Manoharan Thiagarajan, Milford, MI (US)

(21) Appl. No.: 13/916,842

(22) Filed: Jun. 13, 2013

(51) Int. Cl. F01N 3/021; G01M 15/10

(52) U.S. Cl. CPC F01N 3/021; G01M 15/106
USPC 60/311; 73/114.76

(57) ABSTRACT

An exhaust gas treatment system includes a particulate filter to collect particulate matter from exhaust gas flowing therethrough. The particulate filter realizes a pressure thereacross in response to the exhaust gas flow. A delta pressure sensor determines a first pressure upstream from the particulate filter and a second pressure downstream from the particulate filter. A delta pressure module is in electrical communication with the delta pressure sensor. The delta pressure module determines a pressure differential value based on a difference between the first pressure and the second pressure and generates a diagnostic signal based on a plurality of the pressure differential values and a predetermined time period.

### FIELD OF THE INVENTION

Exemplary embodiments of the invention relate to an exhaust gas treatment system of an internal combustion engine and, more particularly, to a diagnostic system to detect a pressure condition of a particulate filter included in an exhaust gas treatment system.

### BACKGROUND

Exhaust gas emitted from an internal combustion engine, particularly a direct injection diesel engine, is a heterogeneous mixture that contains gaseous emissions such as, but not limited to, carbon monoxide (“CO”), unburned hydrocarbons (“HC”) and oxides of nitrogen (“NOₓ”) as well as particulate matter (“PM”) comprising condensed phase materials (liquids and solids).

Typical exhaust gas treatment systems include a particular filter (“PF”), such as a diesel particulate filter, to collect the particulate matter from the exhaust gas. A pressure sensor may also be included in the exhaust gas treatment system to detect the pressure associated with the PF. The pressure detected by the pressure sensor varies according to accumulation of PM in the PF and/or a damaged PF. In addition, the exhaust gas flow rate of the exhaust gas may vary the pressure detected by the pressure sensor. However, normal operating conditions of the vehicle, such as sudden accelerator pedal manipulation, may also vary the exhaust gas flow rate. Therefore, monitoring the instantaneous pressure associated with the PF may not accurately distinguish a faulty PF from normal operating conditions of the vehicle.

### SUMMARY OF THE INVENTION

In one exemplary embodiment, an exhaust gas treatment system includes a particulate filter to collect particulate matter from exhaust gas flowing therethrough. The particulate filter realizes a pressure thereacross in response to the exhaust gas flow. A delta pressure sensor determines a first pressure upstream from the particulate filter and a second pressure downstream from the particulate filter. A delta pressure module is in electrical communication with the delta pressure sensor. The delta pressure module determines a pressure differential value based on a difference between the first pressure and the second pressure and generates a diagnostic signal based on a plurality of the pressure differential values and a predetermined time period.

In another exemplary embodiment, a control module to diagnose an operating condition of a particulate filter comprises a memory to store a plurality of pressure differential values received from a delta pressure sensor that detects pressure at the particulate filter. A delta pressure module is in electrical communication with the memory to generate a diagnostic signal based on the plurality of the pressure differential values and a predetermined time period.

In yet another exemplary embodiment, a method of generating a diagnostic signal that diagnoses an operating condition of a particulate filter comprises determining a first pressure upstream from the particulate filter and a second pressure downstream from the particulate filter. The method further includes determining a plurality of pressure differential values over a predetermined time period. Each pressure differential value is based on a difference between the first pressure and the second pressure. The method further includes generating the diagnostic signal based on the plurality of the pressure differential values and the predetermined time period.

The above features of the invention are readily apparent from the following detailed description when taken in connection with the accompanying drawings.

### BRIEF DESCRIPTION OF THE DRAWINGS

Other features appear, by way of example only, in the following detailed description of embodiments, the detailed description referring to the drawings in which:

FIG. 1 is a schematic diagram of an exhaust gas treatment system in accordance with exemplary embodiments;

FIG. 2 is a block diagram illustrating a control module that determines a pressure condition of a particulate filter according to an exemplary embodiment;

FIG. 3 is a flow diagram illustrating a method of generating a diagnostic signal to detect a high-pressure fail condition of a particulate filter according to an exemplary embodiment;

FIG. 4 is flow diagram illustrating a method of generating a diagnostic signal to detect a low-pressure fail condition of a particulate filter according to an exemplary embodiment;

FIG. 5 is a flow diagram illustrating a method of generating a diagnostic signal according to another exemplary embodiment; and

FIG. 6 is a flow diagram illustrating a method of diagnosing a particulate filter based to an event debouncing scheme according to an exemplary embodiment.

### DESCRIPTION OF THE EMBODIMENTS

The following description is merely exemplary in nature and is not intended to limit the disclosure, its application or uses. It should be understood that throughout the drawings, corresponding reference numerals indicate like or corresponding parts and features. As used herein, the term “module” refers to an application specific integrated circuit (ASIC), an electronic circuit, a processor (shared, dedicated, or group) and memory that executes one or more software or firmware programs, a combinational logic circuit, and/or other suitable components that provide the described functionality. When implemented in software, a module can be embodied in memory as a non-transitory machine-readable storage medium readable by a processing circuit and storing instructions for execution by the processing circuit for performing a method.

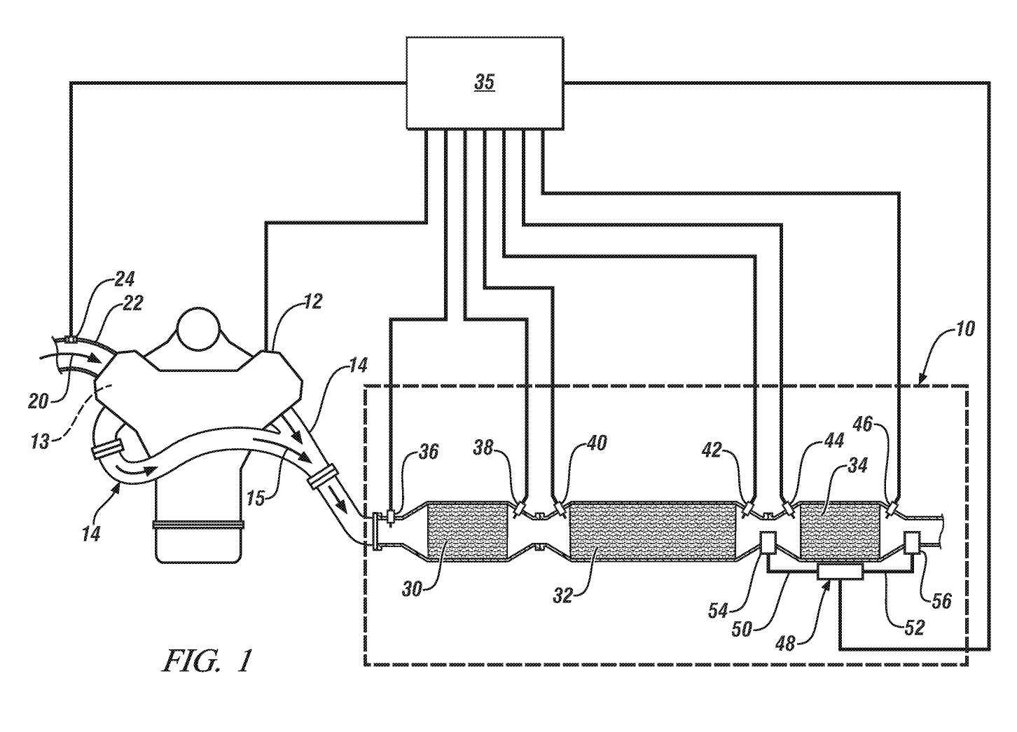

Referring now to FIG. 1, an exhaust gas treatment system 10 of an internal combustion (IC) engine 12 is illustrated according to an exemplary embodiment. The engine 12 may include, but is not limited to, a diesel engine, gasoline engine, and a homogeneous charge compression ignition engine. In addition, the exhaust gas treatment system 10 described herein may be implemented in any of the engine systems mentioned above. The engine 12 includes at least one cylinder 13 to receive fuel, and is configured to receive an intake air 20 from an air intake passage 22. The intake air passage 22 includes an intake mass air flow sensor 24 to determine an intake air mass (m_{Air}) of the engine 12. In one embodiment, the intake mass air flow sensor 24 may include either a vane meter or a hot wire type intake mass air flow sensor. However, it is appreciated that other types of sensors may be used as well. An exhaust gas conduit 14 may convey exhaust gas 15 that is generated in response to combusting the fuel in the cylinder 13. The exhaust gas conduit 14 may include one or more segments containing one or more aftertreatment devices of the exhaust gas treatment system 10, as discussed in greater detail below.

Referring still to FIG. 1, exhaust gas treatment system 10 further includes a first oxidation catalyst (“OC”) device 30, a selective catalytic reduction (“SCR”) device 32, and a particulate filter device (“PF”) 34. In at least one exemplary embodiment of the disclosure, the PF is a diesel particulate filter. It is appreciated that the exhaust gas treatment system 10 of the disclosure may include various combinations of one or more of the aftertreatment devices shown in FIG. 1, and/or other aftertreatment devices (e.g., lean NOₓ traps), and is not limited to the present example.

The first OC device 30 may include, for example, a flow-through metal or ceramic monolith substrate that is packaged in a stainless steel shell or canister having an inlet and an outlet in fluid communication with exhaust gas conduit 14. The substrate may include an oxidation catalyst compound disposed thereon. The oxidation catalyst compound may be applied as a wash coat and may contain platinum group metals such as platinum (“Pt”), palladium (“Pd”), rhodium (“Rh”) or other suitable oxidizing catalysts, or combinations thereof. The OC device 30 may treat unburned gaseous and non-volatile HC and CO, which are oxidized to form carbon dioxide and water.

The SCR device 32 may be disposed downstream from the first OC device 30. The SCR device 32 may include, for example, a flow-through ceramic or metal monolith substrate that may be packaged in a stainless steel shell or canister having an inlet and an outlet in fluid communication with the exhaust gas conduit 14. The substrate may include an SCR catalyst composition applied thereto. The SCR catalyst composition may contain a zeolite and one or more base metal components such as iron (“Fe”), cobalt (“Co”), copper (“Cu”) or vanadium (“V”) which may operate efficiently to convert NOₓ constituents in the exhaust gas 15 in the presence of a reductant such as ammonia.

The PF 34 may be disposed downstream from the SCR device 32, and filters the exhaust gas 15 of carbon and other particulate matter. According to at least one exemplary embodiment, the PF 34 may be constructed using a ceramic wall flow monolith exhaust gas filter substrate that is wrapped in an intumescent or non-intumescent mat (not shown) that expands, when heated to secure and insulate the filter substrate which is packaged in a rigid, heat resistant shell or canister, having an inlet and an outlet in fluid communication with exhaust gas conduit 14. It is appreciated that the ceramic wall flow monolith exhaust gas filter substrate is merely exemplary in nature and that the PF 34 may include other filter devices such as wound or packed fiber filters, open cell foams, sintered metal fibers, etc.

Exhaust gas 15 entering the PF 34 is forced to migrate through porous, adjacently extending walls, which capture carbon and other particulate matter from the exhaust gas 15. Accordingly, the exhaust gas 15 is filtered prior to being exhausted from the vehicle tailpipe. As exhaust gas 15 flows through the exhaust gas treatment system 10, the PF 34 realizes a pressure across the inlet and the outlet. Further, the amount of particulates captured by the PF 34 increases over time, thereby increasing the exhaust gas backpressure realized by the engine 12. The regeneration operation burns off the carbon and particulate matter collected in the filter substrate and regenerates the PF 34.

A control module 35 is operably connected to and monitors the engine 12 and the exhaust gas treatment system 10 through a number of sensors. Referring to FIG. 1, the control module 35 is in electrical communication with the engine 12, the intake mass air flow sensor 24, and various temperature sensors. In at least one embodiment, the temperature sensors include first and second temperature sensors 36, 38 to determine the temperature profile of the first OC device 30, third and fourth temperature sensors 40, 42 to determine the temperature profile of the SCR device 32, and fifth and sixth temperature sensors 44, 46 to determine the temperature profile of the PF 34. The control module 35 may control the engine 12 based on information provided by one or more of the sensors 36, 38, 40, 42, 44, 46. In at least one exemplary embodiment, a single sensor may replace the second and third sensors 38, 40, and a single sensor may replace the fourth and fifth sensors 42, 44.

In addition to the temperature sensors, the exhaust gas treatment system 10 may further include at least one pressure sensor (e.g., a delta pressure sensor 48), in electrical communication with the control module 35 (see FIG. 1). The delta pressure sensor 48 includes a front line 50 and a rear line 52. The front line 50 is coupled to an upstream port 54 disposed upstream from the PF 34 to determine a pressure at a point upstream from the PF 34. The rear line 52 is coupled to a downstream port 56 disposed downstream from the PF 34 to determine a second pressure at a point downstream from the PF. Although FIG. 1 illustrates the delta pressure sensor 48 disposed externally of the exhaust conduit 14, it is appreciated that one of ordinary skill in the art will understand that the delta pressure sensor 48 may be disposed internal to the exhaust conduit 14 or integrated within the PF 34.

In one embodiment, the control module 35 includes control logic to calculate an exhaust gas mass flow within the exhaust gas conduit 14. The exhaust gas mass flow is based on the intake air mass (m_{Air}) of the engine 12 and the fuel mass flow (m_{Fuel}) of the engine 12. As mentioned above, the m_{Air} may be measured by the intake air mass airflow sensor 24. The m_{Fuel} is may be measured by determining the total amount of fuel injected into the engine 12 over a given period of time. The exhaust gas mass flow, therefore, may be calculated by adding m_{Fuel} and m_{Air}. The exhaust gas mass flow may further be used to determine an exhaust gas volume flow rate (dvol), as discussed in greater detail below.

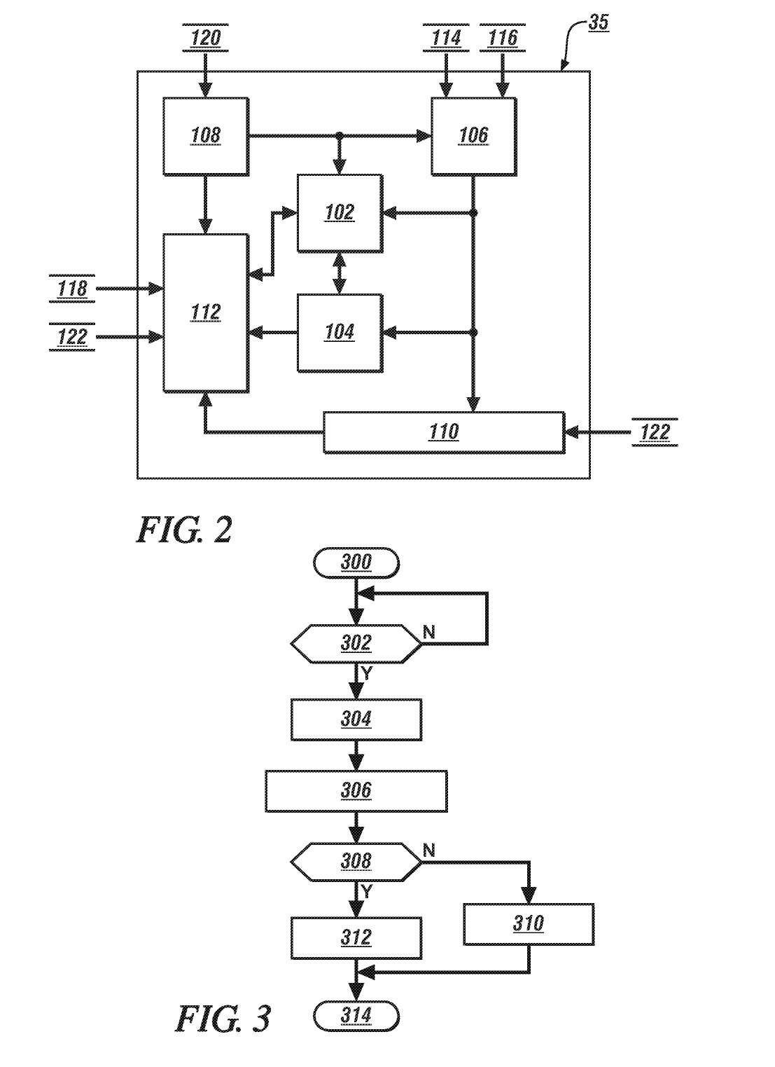

FIG. 2 illustrates a block diagram of a control module 35 that determines a pressure condition of a PF according to at least one exemplary embodiment of the teachings. Various embodiments of the exhaust gas treatment system 10 of FIG. 1 according to the disclosure may include any number of sub-modules embedded within the control module 35. As can be appreciated, the sub-modules shown in FIG. 2 may be combined or further partitioned as well. Inputs to the control module 35 may be sensed from the exhaust gas treatment system 10, received from other control modules, for example an engine control module (not shown), or determined by other sub-modules or modules. As illustrated in FIG. 2, the control module 35 according to at least one embodiment includes a memory 102, a debounce module 104, a regeneration control module 106, an entry condition module 108, a fuel injection control module 110, and a delta pressure module 112.

In one embodiment, the memory 102 of the control module 35 stores a number of configurable limits, maps, and variables that are used to control regeneration of the PF 34, and to determine a pressure differential (i.e., delta pressure) associated with the PF 34. In at least one exemplary embodiment, the delta pressure is a pressure differential between the upstream port 54 and the downstream port 56.

Each of the modules 104-112 interfaces and electrically communicates with the memory 102 to retrieve and update stored values as needed. For example, the memory 102 can provide values to the delta pressure module 112 including, but not limited to, upstream and/or low-stream pressure measurements, to support determination of a pressure differential between the front line 50 and the rear line 52 of the delta pressure sensor 48. The memory 102 may further store one or more threshold values, a plurality of different delta pressure measurements, time periods over which the pressures were measured, and one or more offset values to determine a low pressure and/or high pressure condition of the PF 34. The memory 102 may further store an instantaneous detected pass and/or fail event of the PF 34 and one or more predetermined event threshold values. Accordingly, the debounce module 104 may communicate with the memory 102, and therefore increment one or more counters after a plurality of pass and/or fail events exceeds a predetermined event threshold value.

The regeneration control module 106 may apply algorithms known to those of ordinary skill in the art to determine when to initiate the regeneration operation to regenerate the PF 34. For example, the regeneration mode may be set when a soot load exceeds a threshold defined in the memory 102. Regeneration of the PF 34 of FIG. 1 can be based on or limited according to vehicle operating conditions and exhaust conditions. The vehicle operating conditions 114 and the exhaust conditions 116 can be provided by sensors or other modules. For example, the fifth and sixth temperature sensors 44, 46 (shown in FIG. 1) may send one or more electrical temperature signals 118 to the control module 35 to indicate a temperature profile of the PF 34. The regeneration control module 106 may also receive one or more entry conditions 120 monitored by the entry condition module 108. The entry conditions 120 input to the entry condition module 108 may include, but are not limited to, engine speed, exhaust temperature, time elapsed since a last regeneration, distance traveled since a last regeneration, amount of fuel consumed, exhaust gas volume flow rate within a specific range and the pressure differential across the particulate filter 34. The above-mentioned non-exclusive entry conditions may be monitored to determine when to perform a diagnostic of the PF 34, which is discussed in greater detail below.

The exhaust temperature value may include the temperature profiles of aftertreatment devices such as the first OC device 30, the SCR device 32 and/or the PF 34. In one embodiment, the first and second temperature sensors (shown in FIG. 1) send electrical signals to the control module 35 that indicate the temperature profile of the OC device 30, the third and fourth temperature sensors (shown in FIG. 1) send electrical signals to the control module 35 that indicate the temperature profile of the SCR device 32, and the fifth and sixth temperature sensors (shown in FIG. 1) send electrical signals to the control module 35 that indicate the temperature profile of the PF 34. Alternatively, in another embodiment, the control module 35 may include control logic to determine the temperature profiles of the first OC device 30, the SCR device 32, and the PF 34 based on operating parameters of the engine 12 (shown in FIG. 1).

The mass adsorbed value is a value calculated by the control module 35, and represents the amount of sulfur that is already adsorbed on the first OC device 30, and the SCR device 32 (shown in FIG. 1). The mass adsorbed value is a time integrated value of the amount of sulfur adsorbed (e.g., for example at time=0 seconds, there is generally no sulfur adsorbed, but 10 g/s sulfur entering into the catalyst, at time=1 seconds, there are 10 g of sulfur now adsorbed by the catalyst). The sulfur exposure from the fuel value, the sulfur exposure from the oil value, the capture rate value, the amount of fuel consumed value, the amount of oil consumed value, the exhaust temperature value, and the mass adsorbed value are used to calculate the rate of sulfur adsorption.

The fuel injection control module 110 outputs a fuel injection control signal to control in cylinder post injection in the engine 12 of FIG. 1. In cylinder post injection generates exhaust temperatures to remove stored sulfur from one or more aftertreatment devices and/or to regenerate the PF 34 illustrated in FIG. 1. The fuel injection control module 110 can access values in the memory 102 to set the fuel injection control signal based on the regeneration mode and/or the desulfurization process. The fuel injection control module 110 may also receive a torque command 122 for determining a desired torque for driving the vehicle. The torque command 122 is the basis for the amount of fuel injected into the cylinder 13 of the engine 12. Based on the torque command 122, therefore, the fuel injection control module 110 may determine the fuel mass flow (m_{Fuel}). In at least one embodiment, the fuel injection control module 110 may receive the torque command 122 from an engine control module (not shown) that communicates with the engine 12.

As mentioned above, the exhaust gas mass flow may be based on the intake air mass (m_{Air}) of the engine 12 and the fuel mass flow (m_{Fuel}) of the engine 12. More specifically, the control module 35 may calculate the exhaust gas mass flow by adding m_{Air} to m_{Fuel}. The control module may further calculate an exhaust gas volume flow (dvol) based on the exhaust gas mass flow. In at least one exemplary embodiment, the memory 102 may store the following equation to determine the exhaust gas volume flow:

$$dvol = \frac{( mAir + mFuel ) ( R ) ( TFilter )}{Δ p} , \qquad [ 1 ]$$

where (m_{Air}+m_{Fuel}) is the exhaust gas mass flow;

R is a constant value indicative of a rate of gas flow;

T_{Filter} is the temperature of the PF 34; and

Δp (delta pressure) is the pressure differential associated with the PF 34.

T_{Filter} may be based on measurements by the fifth and sixth temperature sensors 44, 46, and delta pressure may be based on the measurement of the delta pressure sensor 48. Each of the constants and/or measured variables in Equation [1] may be stored in the memory 102. The control module 35 may communicate with the memory 102, and accordingly may calculate the exhaust gas volume flow (dvol). It can be appreciated by one of ordinary skill in the art that the above-mentioned equations are exemplary in nature and other methods to determine the exhaust gas mass flow and/or the exhaust gas volume flow may be used. In at least one exemplary embodiment, the delta pressure module 112 may determine dvol as discussed above.

The delta pressure module 112 is in electrical communication with the delta pressure sensor 48, the memory 102, the debounce module 104, the entry condition module 108, and the fuel injection module 110. Accordingly, the delta pressure module 112 may determine the delta pressure of the PF 34, and based on the delta pressure, may generate a diagnostic signal indicative of one or more operating conditions of the PF 34. The operating conditions of the PF 34 may include, but are not limited to, a damaged PF 34, a dislodged PF 34, a missing PF 34, and a blocked PF 34. The diagnostic signal may also indicate a fault associated with the PF sensor 48. The fault includes, but is not limited to, a disconnection of the rear line 52 from the downstream port 56. Although not shown, the diagnostic signal may be output from the delta pressure module 112 to one or more electronic device for further analysis and/or observation. It is appreciated that the delta pressure module 112 is not limited to generating only one diagnostic signal during operation.

According to a first exemplary embodiment, the delta pressure module 112 generates the diagnostic signal based on a plurality of delta pressure measurements performed over a predetermined time period. By generating the diagnostic signal based on a plurality of delta pressure measurements instead of a single instantaneous pressure condition, actual pressure fail conditions may be distinguished from nominal pressure differential conditions. For example, the diagnostic signal of according to at least one embodiment of the invention may distinguish actual pressure fail conditions from instantaneous increases in exhaust gas flow caused by sudden vehicle accelerations.

In at least one embodiment, the time period (t) may range from approximately 30 seconds to approximately 60 seconds. The diagnostic signal may be calculated as a scalar value (SIGNAL_{DIAGNOSTIC}) according to the following equation:

$${SIGNAL}_{DIAGNOSTIC} = \int \frac{( Δ P ) d t}{d t} , \qquad [ 2 ]$$

where Δp (delta pressure) is the pressure differential associated with the PF 34. As discussed above, Δp (delta pressure) may be the pressure differential associated with the PF 34. In at least one embodiment, the Δp (delta pressure) may be determined by subtracting the downstream pressure measured at the rear line 52 of the delta pressure sensor 48 from the upstream pressure measured at the front line 50. In at least one embodiment of the disclosure, the PF diagnostic signal may be generated by integrating the delta pressure determined by the delta pressure sensor 48 over a predetermined time period (t). Therefore, the diagnostic signal may be indicative of an average pressure differential over the predetermined time period (t), which distinguishes between nominal pressure differential conditions occurring in the exhaust treatment system 10.

As mentioned above, the delta pressure module 112 may communicate with the entry condition module 108. Accordingly, the delta pressure module 112 may initiate generation of the SIGNAL_{DIAGNOSTIC} after one or more entry conditions exist to ensure that the PF 34 is not contaminated with particulate matter and/or to ensure the exhaust gas flow rate is at a rate that allows pressure fail conditions from further being distinguished from nominal pressure differential conditions such as, for example, sudden vehicle accelerations.

In response to generating the diagnostic signal, delta pressure module 112 may compare the SIGNAL_{DIAGNOSTIC} value to at least one predetermined threshold. The at least one predetermined threshold may include a first predetermined threshold value indicating a low-end delta pressure threshold (TH_{LOW}) and a second predetermined threshold value indicating a high-end delta pressure threshold (TH_{HIGH}), which is greater than TH_{LOW}. Accordingly, a low-pressure fail condition may be determined in response to the SIGNAL_{DIAGNOSTIC} value being less than TH_{LOW}, and a high-pressure fail condition may be determined in response to the SIGNAL_{DIAGNOSTIC} value being greater than TH_{HIGH}. The diagnosis of a low-pressure fail condition may be indicative of a faulty and/or missing PF 34. For example, if the filter substrate of the PF 34 is punctured with one or more holes, or if the filter substrate is removed, exhaust gas flow 15 travels through the PF 34 with less resistance, thereby reducing the overall pressure differential between the front line 50 of the delta pressure sensor 48 and the rear line 52.

Alternatively, the diagnosis of a high-pressure fail condition may be indicative of a blocked PF 34. As discussed above, the backpressure upstream from the PF 34 increases as the amount of particulate matter and carbon collected by the filter substrate increases. Accordingly, a diagnosis of a high-pressure fail condition after performing a regeneration of the PF 34 may indicate that the filter substrate and/or the entire PF 34 may need replacement. The diagnosis of a high-pressure fail condition may also indicate a disconnection between the rear line 52 of the delta pressure sensor 48 and the downstream port 56. For example, if rear line 52 becomes disconnected the delta pressure sensor 48 is left monitoring ambient air having a nominal pressure value. This results in the calculation of a higher than normal delta pressure value since the first pressure value measure at the front line 50 is reduced by only a nominal pressure value. In at least one embodiment, first and second high-end delta pressure thresholds may be used to distinguish a disconnected rear line 52 from a blocked PF 34. If the SIGNAL_{DIAGNOSTIC} value is greater than a first high-end delta pressure threshold (TH_{HIGH}_{_{—}}₁), a blocked PF 34 may be determined. If the If the SIGNAL_{DIAGNOSTIC} value is greater than a second high-end delta pressure threshold (TH_{HIGH}_{_{—}}₂) being greater than TH_{HIGH}_{_{—}}₁, than high-pressure fail condition may be attributed to a disconnected rear line 52.

The debounce module 104 electrically communicates with the delta pressure module 112 to record an occurrence of at least one fail event. The event may include a pressure differential pass event and/or a pressure differential fail event. In at least one embodiment of the disclosure, the debounce module 104 is configured to operate according to an event debouncing scheme, as opposed to a time-in-a-row scheme (i.e., instantaneous condition basis). The debounce module 104 may communicate with the delta pressure module 112 to determine the occurrence of a low-pressure and/or high-pressure fail condition. In response to a plurality of the fail conditions exceeding a predetermined count threshold, the debounce module 104 may output a fail signal to the delta pressure module 112 indicating a pressure fail event. The debounce module 104, therefore, may add an additional condition taken into account by the delta pressure module 112 when diagnosing the PF 34. Further, the counter may be reset when a predetermined number of pass conditions occur to confirm a pass event. The pass event may be confirmed when a plurality of pass conditions exceed a passing threshold and/or a predetermined number of passing events occur in a row. By determining a fail event based on an event debouncing scheme, an actual fail pressure condition of the PF 34 may be distinguished from nominal fluctuations in exhaust gas flow rate caused from, for example, spontaneous or inadvertent vehicle accelerations.

In another exemplary embodiment, a predetermined offset value (Q) stored in the memory 102 may be applied to the measured delta pressure value (Δp). In at least one embodiment, the offset value (Q) reduces Δp to generate an offset diagnostic signal. The offset diagnostic signal may be calculated as an offset scalar value (SIGNAL_{DIAGNOSTIC}_{_{—}}_{OFFSET}) according to the following equation:

$${SIGNAL}_{DIAGNOSTIC \_ OFFSET} = \int \frac{( Δ P - Q ) d t}{d t} , \qquad [ 2 ]$$

Accordingly, the delta pressure module 112 generates an offset diagnostic signal that is an average of a plurality of offset pressure differential values over the predetermine time period (t). The offset diagnostic signal may then be compared to TH_{LOW} and/or TH_{HIGH}, to determine a low-pressure fail condition and/or high-pressure fail condition as discussed in detail above.

In yet another exemplary embodiment of the disclosure, a diagnostic signal may be determined for a particular exhaust gas volume flow rate (dvol) bin, i.e., a particular dvol range, among a plurality of dvol bin. For example, the memory 102 may store a first dvol bin ranging from approximately 900 m³/hr to approximately 1000 m³/hr, a second dvol bin ranging from approximately 1000 m³/hr to approximately 1100 m³/hr, and a third dvol bin ranging from approximately 1100 m³/hr to approximately 1200 m³/hr. The memory 102 may also store corresponding a TH_{LOW} and/or TH_{HIGH} for each stored dvol bin. In at least one embodiment, the TH_{LOW} and/or TH_{HIGH} may be different for each dvol bin. The delta pressure module 112 may determine a current, i.e., real time, dvol of the exhaust gas 15 in response to one or more entry conditions being satisfied. The delta pressure module 112 may then generate the diagnostic signal or the offset diagnostic signal as discussed above, and may compare the generated diagnostic signal to the TH_{LOW} and/or TH_{HIGH} that corresponds of the current dvol bin.

In still another embodiment, the effect of the dvol on the TH_{LOW} and/or TH_{HIGH} is taken into account. More specifically, as the dvol increases, the range between thresholds increases. Accordingly, violations of the TH_{LOW} and/or TH_{HIGH} at high dvol bins are more likely actual pass/fail pressure conditions as opposed to a random violation of the a threshold that may be caused by a nominal vehicle operation condition, such as sudden vehicle acceleration. Therefore, at least one embodiment of the disclosure applies a weighted value to the diagnostic signal and/or offset diagnostic signal based on the current dvol of the exhaust gas 15. In one exemplary embodiment, the weighted value to be applied to the generated diagnostic signal increases as the dvol increases. For example, a diagnostic signal generated at a dvol of 900 m³/hr may be weighted using a first predetermined scalar value (WEIGHT_{—}900), while a diagnostic signal generated at a dvol of 2000 m³/hr may be weighted using a second predetermined scalar value (WEIGHT_{—}2000), which is greater than WEIGHT_{—}900.

Turning to FIG. 3, a flow diagram illustrates a method of generating a diagnostic signal to detect a high-pressure fail condition of a PF according to an exemplary embodiment. The method begins at operation 300 and proceeds to operation 302 where a determination is made as to whether one or more entry conditions are met. If the entry conditions are not met, the method returns to operation 302 and monitoring of the entry conditions continues. Otherwise, a plurality of pressure differentials (Δp) are measured over a predetermined time period (t) at operation 304. At operation 306, a Δp diagnostic signal is generated based on the plurality of pressure differentials (Δp) and the predetermined time period (t). For example, the plurality of pressure differentials (Δp) may be integrated over the predetermined time period (t) to generate a Δp diagnostic signal indicative of an average pressure differential over the time period (t). At operation 308, the Δp diagnostic signal is compared to a high-pressure threshold (TH_{HIGH}). If the Δp diagnostic signal is below TH_{HIGH}, a passing condition is determined at operation 310, and the method ends. If the Δp diagnostic signal is above TH_{HIGH}, a failing condition is determined at operation 312, and the method ends at operation 314. Accordingly, the high-pressure fail condition may indicate a failure associated with the PF including, for example, a blocked PF and/or a disconnected rear line of the delta pressure sensor.

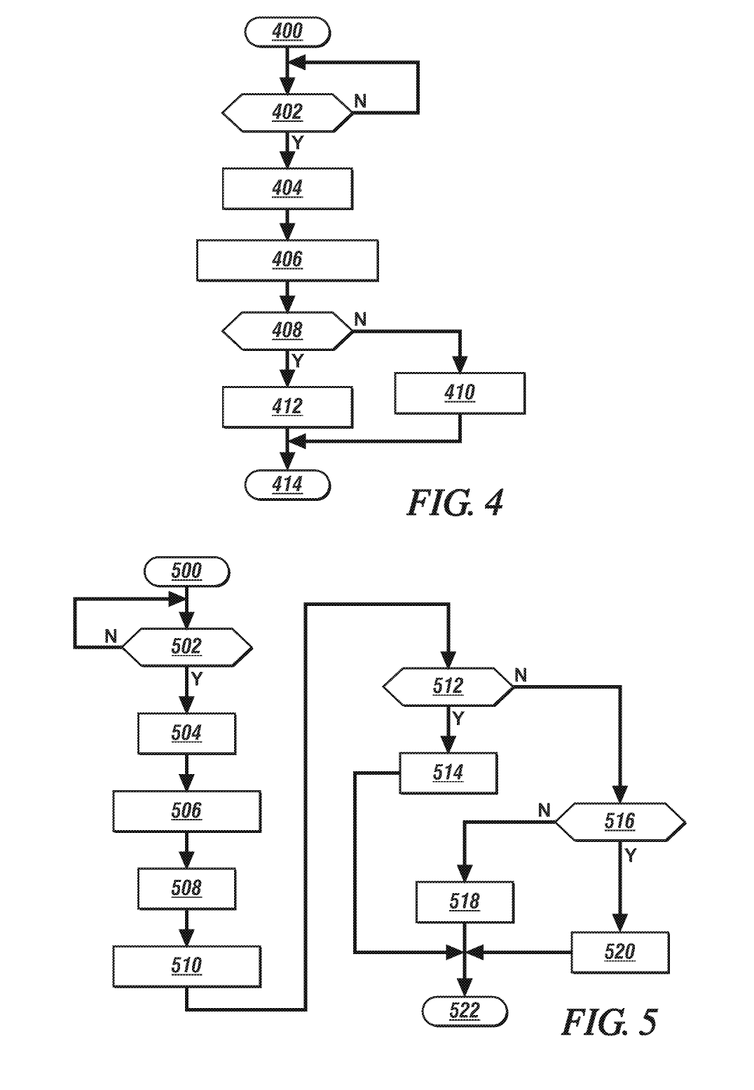

Referring now FIG. 4, a flow diagram illustrates a method of generating a diagnostic signal to detect a low-pressure fail condition of a PF according to an exemplary embodiment. The method begins at operation 400, and proceeds to operation 402 where a determination is made as to whether one or more entry conditions are met. If the entry conditions are not met, the method returns to operation 402 and monitoring of the entry conditions continues. Otherwise, a plurality of pressure differentials (Δp) are measured over a predetermined time period (t) at operation 404. At operation 406, a Δp diagnostic signal is generated based on the plurality of pressure differentials (Δp) and the predetermined time period (t). For example, the plurality of pressure differentials (Δp) may be integrated over the predetermined time period (t) to generate a Δp diagnostic signal indicative of an average pressure differential over the time period (t). At operation 408, the Δp diagnostic signal is compared to a low-pressure threshold (TH_{LOW}). If the Δp diagnostic signal is above TH_{LOW}, a passing condition is determined at operation 410, and the method ends. If the Δp diagnostic signal is below TH_{LOW}, a failing condition is determined at operation 412, and the method ends at operation 414. Accordingly, the low-pressure fail condition may indicate a failure of the PF including, for example, a missing and/or damaged filter substrate.

Turning to FIG. 5, a flow diagram illustrates a method of generating a diagnostic signal according to another exemplary embodiment. The method begins at operation 500, and proceeds to operation 502 where a determination as to whether one or more entry conditions are met. If the entry conditions are not met, the method returns to operation 502 and monitoring of the entry conditions continues. Otherwise, a real time exhaust gas volume flow rate (dvol) is determined at operation 504. At operation 506, a low-pressure threshold (TH_{LOW}) and a high-pressure threshold (TH_{HIGH}) corresponding to the dvol is determined. At operation 508, a plurality of pressure differentials Δp corresponding to a PF is determined. The pressure differentials may be determined according to a difference between a first pressure measured upstream from the PF and second pressure measured downstream from the PF. At operation 510, a Δp diagnostic signal is generated based on the plurality of Δp. For example, the Δp diagnostic signal may be generated by integrating the plurality of Δp over a predetermined time period.

The Δp diagnostic signal generated at operation 510 may be used diagnose the PF. More specifically, the Δp diagnostic signal is compared to TH_{LOW} at operation 512. If the Δp diagnostic signal is below TH_{LOW}, a first fail condition such as a missing substrate may be determined at operation 514 and the method ends. If the Δp diagnostic signal is above TH_{LOW}, a determination as to whether the Δp diagnostic signal exceeds TH_{HIGH} is performed at operation 516. A passing condition is determined at operation 518 if the Δp diagnostic signal is above TH_{HIGH}. Otherwise, a second failed condition is determined at operation 520 and the method ends at operation 522. The second failed condition may include, for example, a blocked PF and/or a disconnected rear line of a delta pressure sensor.

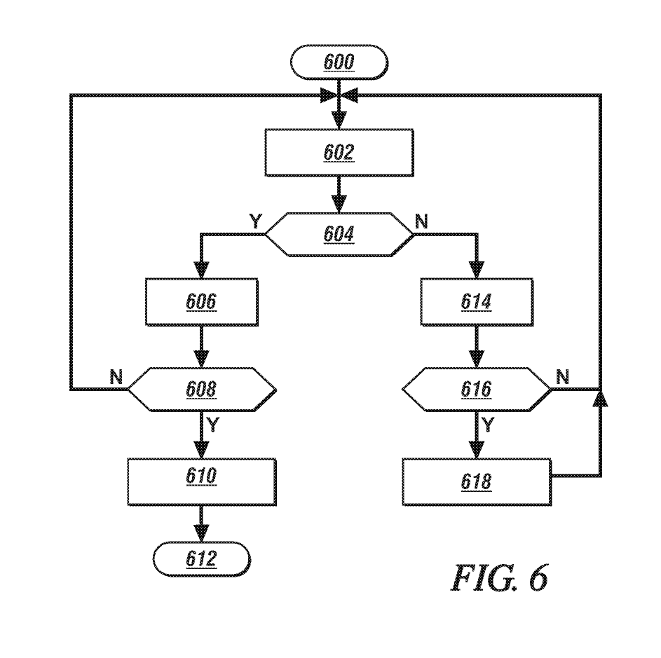

Referring to FIG. 6, a flow diagram illustrates a method of diagnosing a PF based on an event debouncing scheme according to an exemplary embodiment. The method begins at operation 600 and proceeds to operation 602 where a diagnostic signal is generated based on plurality of pressure differentials (Δp) measured over a predetermined time period (t). At operation 604, the diagnostic signal is compared to a high-pressure threshold (TH_{HIGH}). If the diagnostic signal is above TH_{HIGH}, then a fail counter is incremented at operation 606 indicating the occurrence of a fail event. At operation 608, a determination is made as to whether a number of consecutive fail events exceed a predetermined threshold count value (TH_{FAIL}). If the number of consecutive pass events does not exceed TH_{FAIL} then the method returns to operation 602 and another diagnostic signal is generated. However if the number of consecutive fail events exceeds TH_{FAIL}, then a fail condition, such as a blocked PF and/or a disconnected rear line of a delta pressure sensor, is determined at operation 610 and the method ends at operation 612.

Turning again to operation 604, if the diagnostic signal is below TH_{HIGH}, then a pass event is determined at operation 614. At operation 616, a determination is made as to whether a number of consecutive pass events exceed a predetermined threshold count value (TH_{PASS}). If the number of consecutive pass events does not exceed TH_{PASS}, then the method returns to operation 602 and another diagnostic signal is generated. However, if the number of consecutive pass events exceeds TH_{PASS}, then the fail counter is reset at operation 618, and the method returns to operation 602 to generate another diagnostic signal. Accordingly, a failed PF is determined after a predetermined number of failed events occur as opposed to determining a failed PF after each failed condition. By determining a fail event based on an event debouncing scheme, an actual fail pressure condition of the PF may be distinguished from nominal fluctuations in exhaust gas flow rate caused from, for example, spontaneous or inadvertent vehicle accelerations.

While the invention has been described with reference to exemplary embodiments, it will be understood by those skilled in the art that various changes may be made and equivalents may be substituted for elements thereof without departing from the scope of the application. In addition, many modifications may be made to adapt a particular situation or material to the teachings of the invention without departing from the essential scope thereof. Therefore, it is intended that the invention not be limited to the particular embodiments disclosed, but that the invention will include all embodiments falling within the scope of the application.

1. An exhaust gas treatment system included with an internal combustion engine, comprising:
a particulate filter to collect particulate matter from exhaust gas flowing therethrough, the particulate filter realizing a pressure thereacross in response to the exhaust gas;
a delta pressure sensor to determine a first pressure upstream from the particulate filter and a second pressure downstream from the particulate filter; and
a delta pressure module in electrical communication with the delta pressure sensor to determine a pressure differential value based on a difference between the first pressure and the second pressure and to generate a diagnostic signal based on a plurality of the pressure differential values and a predetermined time period; and
a debounce module in electrical communication with the delta pressure module to count a plurality of fail conditions over the predetermined time period, and to generate a fail signal indicating a pressure fail event in response to the plurality of the fail conditions exceeding a predetermined count threshold.

2. The exhaust gas treatment system of claim 1, wherein the delta pressure sensor includes a front line coupled to a first port disposed upstream from the particulate filter to determine the first pressure and includes a rear line coupled to a second port disposed downstream from the particulate filter to determine the second pressure.

3. The exhaust gas treatment system of claim 2, wherein the delta pressure module determines at least one fail condition of the particulate filter based on a comparison between the diagnostic signal and at least one threshold value.

4. The exhaust gas treatment system of claim 3, wherein the at least one fail condition includes a low-pressure fail condition and a high-pressure fail condition.

5. The exhaust gas treatment system of claim 4, wherein the delta pressure module determines the low-pressure fail condition in response to the diagnostic signal existing below a first predetermined threshold and determines the high-pressure fail condition in response to the diagnostic signal existing above a second predetermined threshold.

6. The exhaust gas treatment system of claim 5, wherein the low-pressure fail condition indicates a damaged particulate filter, and the high-pressure condition indicates at least one of a blockage of the particulate filter and a miscommunication between the rear line of the delta pressure sensor and the downstream port.

7. (canceled)

8. The exhaust gas treatment system of claim 6, further comprising an entry condition module in electrical communication with the delta pressure module to generate an entry condition signal in response to the occurrence of the at least one entry condition, wherein the delta pressure module generates the diagnostic signal in response to receiving the entry condition signal.

9. A control module to diagnose an operating condition of a particulate filter for an internal combustion engine, comprising:
a memory to store a plurality of pressure differentials received from a delta pressure sensor that detects pressure at the particulate filter;
a delta pressure module in electrical communication with the memory and the delta pressure sensor to generate a diagnostic signal based on the plurality of the pressure differential values received by the delta pressure sensor, and to determine at least one fail condition of the particulate filter based on a comparison between the diagnostic signal and at least one threshold value; and
a debounce module in electrical communication with the delta pressure module to count a plurality of fail conditions over a predetermined time period, and to generate a fail signal indicating a pressure fail event in response to the plurality of the fail conditions exceeding a predetermined count threshold.

10. The control module of claim 9, wherein the memory stores an offset value, and the delta pressure module applies the offset value to each pressure differential to generate an offset diagnostic signal.

11. (canceled)

12. The control module of claim 10, wherein the at least one fail condition includes a low-pressure fail condition and a high-pressure fail condition.

13. The control module of claim 12, wherein the delta pressure module determines the low-pressure fail condition in response to the diagnostic signal existing below a first predetermined threshold and determines a high-pressure fail condition in response to the diagnostic signal existing above a second predetermined threshold.

14. The control module of claim 13, wherein the delta pressure module determines a damaged particulate filter based on the low-pressure fail condition, and determines at least one of a blockage of the particulate filter and a disconnection of a rear line of the delta pressure sensor based on the high-pressure condition.

15. The control module of claim 14, wherein the memory stores a lookup table including plurality of exhaust gas volume flow ranges mapped to at least one corresponding threshold value, the delta pressure module determining a real time exhaust gas volume flow rate and generating the diagnostic signal based on the at least one mapped threshold value corresponding to the real time exhaust gas volume flow rate.

16. The control module of claim 14, wherein the memory stores a lookup table including plurality of exhaust gas volume flow rates mapped to respective weighted values, and wherein the delta pressure module determines a real time exhaust gas volume flow rate, maps the real time exhaust gas volume flow to the respective weighted value, and applies the weighted value to the diagnostic signal to generate a weighted diagnostic signal.

17. A method of generating a diagnostic signal that diagnoses an operating condition of a particulate filter, the method comprising:
determining a first pressure upstream from the particulate filter;
determining a second pressure downstream from the particulate filter;
determining a plurality of pressure differential values over a predetermined time period, each pressure differential value based on a difference between the first pressure and the second pressure; and
generating a diagnostic signal based on the plurality of the pressure differential values and the predetermined time period;
determining at least one fail condition of the particulate filter based on a comparison between the diagnostic signal and at least one threshold value; and
counting a plurality of fail conditions over a predetermined time period, and generating a fail signal indicating a pressure fail event in response to the plurality of the fail conditions exceeding a predetermined count threshold.

18. (canceled)

19. The method of claim 17, further comprising determining a low-pressure fail condition in response to the diagnostic signal existing below a first predetermined threshold and determining a high-pressure fail condition in response to the diagnostic signal existing above a second predetermined threshold being greater than the first predetermined threshold.

20. The method of claim 19, further comprising detecting a damaged particulate filter in response to determining the low-pressure fail condition, and detecting at least one of a blockage of the particulate filter and a disconnection of a rear line of the delta pressure sensor in response to determining the high-pressure fail condition.
